(19) United States
(12) Patent Application Publication
(10) Pub. No.: US 2010/0149939 A1
(43) Pub. Date: Jun. 17, 2010

(54) OPTICAL DISC RECORDING METHOD AND OPTICAL DISC APPARATUS

(76) Inventor: Yurak SON, Seoul (KR)

Correspondence Address: BIRCH STEWART KOLASCH & BIRCH, PO BOX 747, FALLS CHURCH, VA, 22040-0747, US

(21) Appl. No.: 12/638,615

(22) Filed: Dec. 15, 2009

(30) Foreign Application Priority Data
Dec. 17, 2008 (KR) 10-2008-0128518

(51) Int. Cl. G11B 20/18

(52) U.S. Cl. 369/53.17; G9B/20.046

(57) ABSTRACT

This document relates to a method capable of reducing transfer errors of a sled motor for moving an optical pickup to the outer circumference when labels are recorded on a disc. An optical disc recording method may comprise checking a step pattern having a small transfer error in the sled motor, and recording labels on a label plane of an optical disc while driving the sled motor based on the checked step pattern. Step patterns can be classified based on a structure of the sled motor or a unit for driving the sled motor. The step patterns having a small transfer error can be detected in a process of manufacturing an optical disc apparatus and stored in memory of the optical disc apparatus.

This application claims the benefit of Korean Patent Application No. 10-2008-0128518 filed on Dec. 17, 2008, which is hereby incorporated by reference.

### BACKGROUND

1. Field

This document relates to an optical disc recording method and, more particularly, to a method capable of reducing transfer errors of a sled motor for moving an optical pickup to the outer circumference when recording labels on a disc.

2. Related Art

An optical disc apparatus and discs for label recording, such as LightScribe discs, enabling label printing on a plane opposite to the data plane on which data are recorded, are being popularized. The plane on which labels are recorded, of a disc for label recording, is called a label plane.

In the data plane of an optical disc, a recording layer in which marks are formed is formed in a disc for recording, pits are formed in a disc for playback and an additional reflection layer are formed. When an optical pickup radiates a laser beam on the data plane, the radiated laser beam is reflected from the reflection layer and is then incident on separated cells of a photo detector (PD) of the optical pickup. A focusing error signal and a tracking error signal can be generated based on signals outputted from the separated cells of the PD.

When performing a disc playback operation or a disc recording operation requested by a user, an optical disc apparatus performs a focusing servo operation for moving the object lens of the optical pickup in the up and down directions and a tracking servo operation for moving the object lens in the inner and outer circumference directions such that focusing error signals and tracking error signals generated in response to signals reflected from the data plane of the optical disc can be minimized. A method of receiving a feedback error signal and performing a servo operation in response to the feedback error signal as described above is called servo of a feedback method.

However, since the label plane of the Light Scribe disc does not have the reflection layer and has a very rough plane as compared with the data plane, the error signals enabling the focusing servo of a feedback method are not generated from the label plane. Accordingly, the focusing servo of a feedback method cannot be performed for the Light Scribe disc, and the focusing servo of a feed forward method is inevitably performed for the Light Scribe disc.

Lands and grooves for performing the tracking servo operation during the data recording process are formed in the data plane of an optical disc for recording, and information (for example, ATIP information) for detecting the current position is also recorded on the data plane in a wobbled land and groove shape. Accordingly, the optical disc recording apparatus can perform the tracking servo operation of a feedback method based on push-pull signals generated from the lands and grooves, check the current position based on the ATIP information recorded on the data plane, and randomly access a desired position.

However, since the wobbled lands and grooves for the tracking servo and the random access are not formed in the label plane of a disc for label recording, the optical disc recording apparatus cannot perform the tracking servo operation of a feedback method based on the error signals, such as the push-pull signals, and also cannot randomly access a desired position. Accordingly, labels are indispensably sequentially recorded on a disc from the inner circumference to the outer circumference of the disc only in the feed forward method.

This movement from the inner circumference to the outer circumference depends on the transfer of a sled motor and the movement of a tracking actuator. It is therefore inevitable that label printing on the label plane is sensitive to the dynamic characteristics of the sled motor and the tracking actuator of the optical pickup in relation to tracking servo. In particular, when the optical pickup is moved to the outer circumference, blanks on which labels are not printed are generated or labels are redundantly printed because of transfer errors generated by the sled motor, thereby deteriorating the recording quality.

Despite the problems, the conventional optical disc apparatus does not correct transfer errors of the sled motor or corrects transfer errors of the sled motor only by moving the tracking actuator even though performing correction, which has little effect.

### SUMMARY

An aspect of this document is to provide a method of improving the label printing quality of a disc for label recording.

Another aspect of this document is to provide a method capable of reducing transfer errors of a sled motor when labels are printed on a disc for label recording.

An optical disc recording method according to an embodiment of this document comprises checking a step pattern having a small transfer error in a sled motor and recording labels on the label plane of an optical disc while driving the sled motor based on the checked step pattern.

In an embodiment, step patterns may be classified based on a structure of the sled motor or a unit for driving the sled motor.

In an embodiment, the step patterns having a small transfer error may be detected in a process of manufacturing an optical disc apparatus and stored in the memory of the optical disc apparatus or may be detected when the data plane of the optical disc is inserted as a seating plane and stored in the memory of the optical disc apparatus.

In an embodiment, if k(k=0, 1, . . . , n−1)^{th} step pattern of an n number of step patterns has a small transfer error, a (n, k) value may be stored in the memory. If a number of the (n, k) values with different n values are stored in the memory, a (n, k) value corresponding to a unit for driving the sled motor may be selected, and the sled motor is driven based on the selected (n, k) value.

An optical disc apparatus according to another embodiment of this document may comprise an optical pickup configured to read data from a data plane of an optical disc and record data on the data plane or a label plane of the optical disc, a sled motor configured to move the optical pickup to an inner or outer circumferences, memory configured to store step patterns having a small transfer error in the optical pickup resulting from the sled motor, and a controller configured to search the memory for the step pattern having a small transfer error and drive the sled motor based on the retrieved step pattern such that labels may be recorded on a label plane of an optical disc.

### BRIEF DESCRIPTION OF THE DRAWINGS

The accompany drawings, which are included to provide a further understanding of the invention and are incorporated on and constitute a part of this specification illustrate embodiments of the invention and together with the description serve to explain the principles of the invention.

FIG. 1 is a layout diagram of the label plane of a LightScribe disc;

FIG. 2 shows media ID fields, an index mark, and Saw-teeth areas which are included in the Control Feature Zone of the LightScribe disc;

FIG. 3 shows the Saw-teeth area and spokes;

FIG. 4 shows the construction of an optical disc apparatus comprising a sled motor for moving an optical pickup;

FIG. 5 shows an example in which blanks where labels are not printed are generated or labels are redundantly printed because of transfer errors of the sled motor;

FIG. 6 shows a physical structure in which rotation is generated in a sled motor using a step motor;

FIG. 7 is a graph showing results of measuring transfer errors of the sled motor for each step input;

. FIG. 8 is a diagram showing transfer errors when labels are written while rotating the sled motor in odd-numbered pattern and labels are written while rotating the sled motor in even-numbered pattern;

FIG. 9 is a diagram illustrating a method of reading an address (physical sector number (PSN)) from the recording plane of an optical disc and converting the read address into a radius of the disc;

FIG. 10 is a diagram showing an embodiment referring to the construction of an optical disc apparatus to which this document is applied; and

FIG. 11 is a flowchart illustrating an optical disk recording method according to an embodiment of this document.

### DETAILED DESCRIPTION

Hereinafter, an optical disc recording method and an optical disc apparatus according to embodiments of this document will be described in detail with reference to the attached drawings.

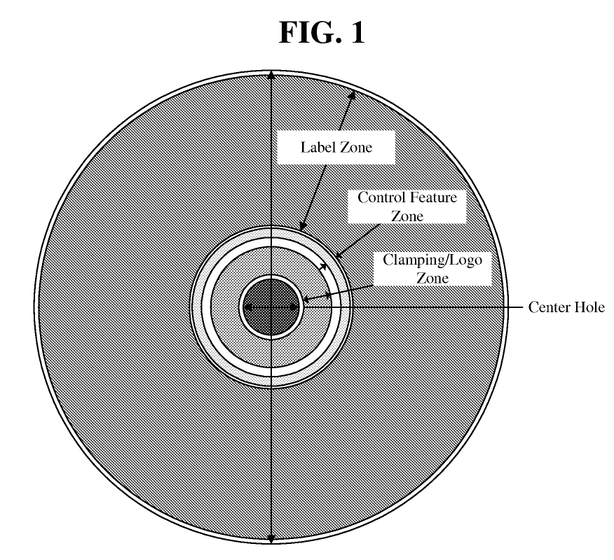

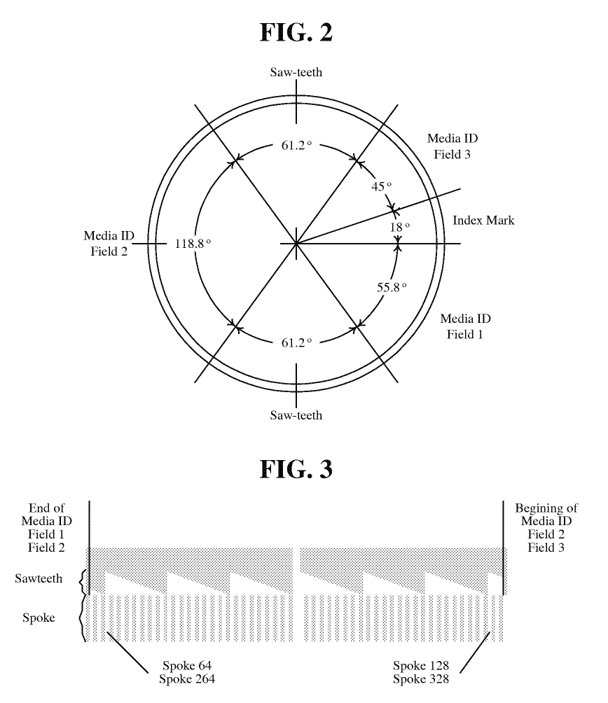

The layout of a label plane of a LightScribe recording disc is shown in FIG. 1. As shown in FIG. 2, the LightScribe disc includes a Control Feature Zone (i.e., zone including patterns for performing servo in the feed forward method). An index mark area, media ID areas (Media ID Field 1, 2, 3) such as media IDs, and saw-teeth areas are assigned to the Control Feature Zone. The media IDs are classified into discontinuous 3 fields, and the saw-teeth areas are separated from each other with the media ID fields interposed therebetween.

FIG. 3 shows the saw-teeth area and spokes. The saw-teeth area of 650 [symbol] in width is separated into two areas facing each other by taking the eccentricity of the disc into consideration. The index marks are used to synchronize spoke 0. The spoke 0 is started at the end position of the index mark. The spoke 0 is a reference position in the circumference direction of the disc. 400 spokes exist in the disc. When the disc is rotated once, the current position in the circumference can be checked by detecting the index mark and the spokes.

In the saw-teeth area, portions having a high reflectance and portions having a low reflectance are engaged with each other in a triangle sawtooth form. When the disc is rotated with a laser beam placed at the center of the saw-teeth area, the duty ratio of a reflected signal becomes 50%. However, in the case where an object lens is made biased in the inner circumference direction or the outer circumference direction by applying a predetermined voltage to the actuator of a track direction (i.e., when the disc is rotated in the state in which the laser beam is biased from the center of the control feature zone to the inner circumference direction or the outer circumference direction), the duty ratio of a reflected signal becomes less than or more than 50%.

Accordingly, an optical disc apparatus enabling label recording measures an actual sensitivity of the actuator in the track direction (i.e., the amount of voltage that should be applied to the actuator in order to move the object lens to the outer circumference by a predetermined distance) using the above method and performs the tracking servo of a feed forward method based on a result of measuring the actual sensitivity (i.e., the amount of voltage).

A feed forward tracking servo through the movement of the actuator for supporting the object lens in the outer circumference direction and the movement of the sled motor, in relation to the movement of the object lens in order to record labels on the label plane of the optical disc, is briefly described below.

To sequentially print labels on an optical disc from the inner circumference to the outer circumference of the label zone of the optical disc, the optical disc apparatus, on a large scale, moves the entire optical pickup to the outer circumference by a predetermined distance using the sled motor and, on a small scale, slowly moves the actuator for supporting the object lens to the outer circumference with the optical pickup being fixed.

With the object lens moved from the center of the optical pickup to the inner circumference direction or the outer circumference direction, the optical and electrical performances are deteriorated. Accordingly, when the object lens is deviated from the center of the optical pickup in the outer circumference direction by a predetermined distance or more, the sled motor operates to move the entire optical pickup in the outer circumference direction. While the entire optical pickup is moved, the object lens placed in the outer circumference of the optical pickup has to be moved to the center of the optical pickup or the inner circumference of the optical pickup.

For example, assuming that the optical performance is greatly deteriorated when the object lens is biased toward the inner or outer circumference by 100 [symbol] from the center of the optical pickup, the entire optical pickup has to be moved when the object lens is moved toward the inner or outer circumference by a value less than 100 [symbol] (for example, 75 [symbol] ). In this case, a minimum unit in which the sled motor can move the optical pickup can be determined as 150 [symbol] (i.e., two times the 75 [symbol] ). That is, if the object lens is moved in the outer circumference direction by 75 [symbol] , the sled motor has to move the entire optical pickup by 150 [symbol] in the outer circumference direction and, at the same time, the actuator has to operate to drive the object lens in the inner circumference direction by a 150 [symbol] -track pitch (i.e., a 75 [symbol] -track pitch from the center of the optical pickup) about the current position of the object lens in the optical pickup. In other words, if the actuator is moved in the outer circumference direction by a predetermined distance, the entire optical pickup has to move to the outer circumference by a minimum unit and, at the same time, the actuator has to move in the inner circumference direction.

Labels can be recorded on the disc using a method of recording the labels on the disc in a concentric circle while rotating the disc once at the current position of the object lens, moving the object lens to the outer circumference by a predetermined distance using the tracking actuator, and then rotating the disc once at the moved position. Alternatively, labels can be spirally recorded on the disc using a method of slowly moving the object lens to the outer circumference by driving the tracking actuator while the disc is rotated.

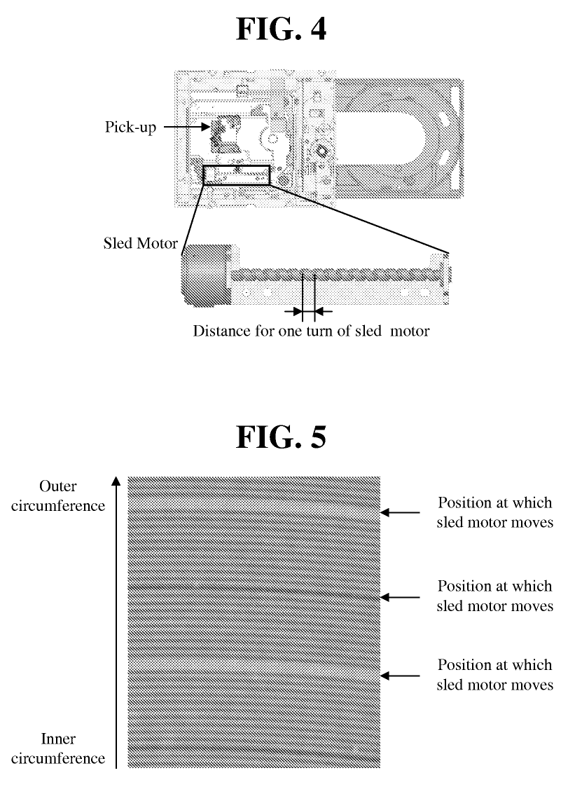

One of the important factors to determine the recording quality of an optical disc in relation to the tracking servo operation is the dynamic characteristic of the sled motor for moving the optical pickup in the inner and outer circumference directions. The construction of an optical disc apparatus including the sled motor for moving the optical pickup is shown in FIG. 4. The sled motor, as shown in FIG. 4, comprises the step motor and a mechanical instrument for transforming the rotational motion of the step motor into motion of straight line. In general, step errors can occur because of mechanical factors, such as angular errors of frame/yoke teeth and irregularity in the inside diameter of an assembly of frame/yoke teeth, and electrical factors, such as winding resistance, irregularity in the inter-phase of inductance, and irregularity of a magnetic flux occurring on the surface of each tooth.

Although the optical disc apparatus constructed as shown in FIG. 4 compensates for the dynamic characteristic of the actuator through operations in the saw-teeth area of a disc for label recording, it cannot compensate for transfer errors occurring in the sled motor when moving the optical pickup to the outer circumference. Consequently, blanks in which labels are not printed are generated or labels are redundantly printed, as shown in FIG. 5.

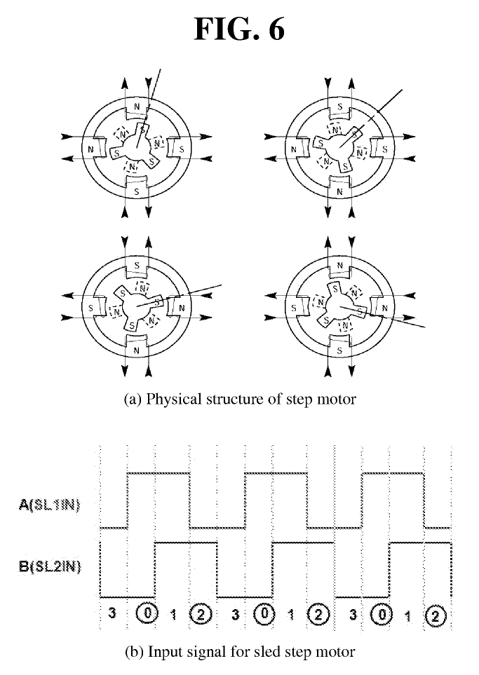

FIG. 6 shows a physical structure in which rotation is generated in a sled motor using a step motor. As shown in FIG. 6, the sled motor has a periodic characteristic according to the step inputs of a four unit. That is, for every step, a rotor is rotated with it being electromagnetically in equilibrium with four stators that form an angle of 90° each other. When four step inputs are generated, the rotor is rotated at an angle of 90° until a relative position between the rotor and the stators becomes identical to a position before the four step inputs.

When performing printing on the label plane of a disc for label recording, the optical disc apparatus rotates the sled motor by inputting two steps to the step motor once. Accordingly, when the optical pickup is moved by the step motor, two kinds of step patterns (i.e., even-numbered step pattern and odd-numbered step pattern) are generated. For example, the even-numbered step pattern can have [0 2 0 2 . . . ] pattern, and the odd-numbered step pattern can have a [1 3 1 3 . . . ] pattern.

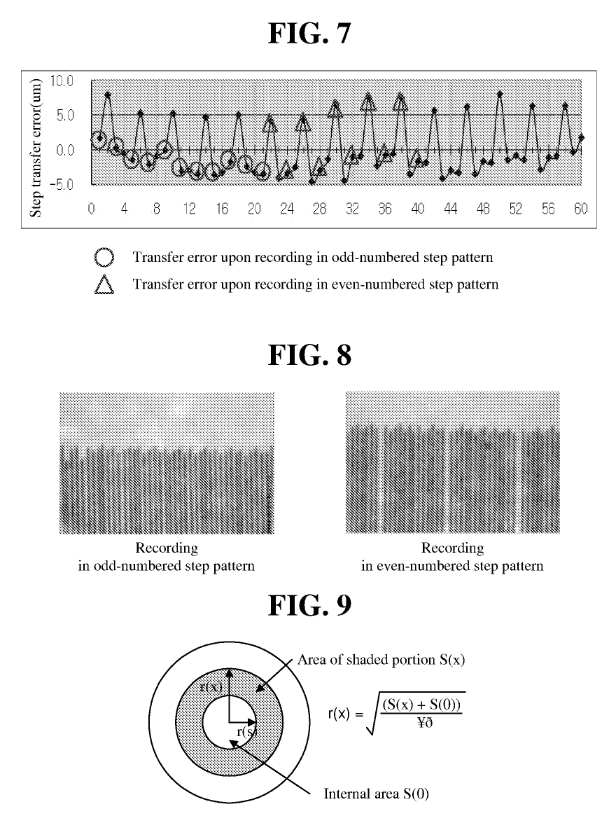

FIG. 7 is a graph showing results of measuring transfer errors of the sled motor for each step input. From FIG. 7, it can be seen that a step having a significant transfer error is generated for every four step intervals. In FIG. 7, the step having the significant transfer error can be expressed by ‘4n+2’. Since the sled motor is moved for every 2 steps when labels are printed, the transfer error is not significant in [1, 3, 5, 7, . . . ] steps (i.e., odd-numbered pattern), but the transfer error is significant in [2, 4, 6, 8, . . . ] steps (i.e., even-numbered pattern).

FIG. 8 shows results of comparing transfer errors when labels are recorded while rotating the sled motor in odd-numbered step pattern and labels are recorded while rotating the sled motor in even-numbered step pattern. From FIG. 8, it can be seen that more stripes where labels are not printed are generated when the labels are printed in the even-numbered step pattern, having a relatively greater transfer error than the odd-numbered step pattern, than when the labels are printed in the odd-numbered step pattern because of the transfer error between two steps.

Accordingly, to prevent deterioration of the label printing quality, such as stripes, a step pattern having a small transfer error can be detected and stored, and labels can be printed using the stored step pattern.

To this end, the sled motor may be driven in the step unit, an address may be read from the data plane of a disc on which data are recorded while moving the optical pickup, a transfer error in each step may be obtained by converting the read address into a radius, transfer errors in even-numbered steps and transfer errors in odd-numbered steps may be calculated, and a step pattern having a small transfer error may be obtained based on a result of the calculation.

FIG. 9 illustrates an equation for reading an address (physical sector number (PSN)) from the recording plane of an optical disc (for example, DVD-ROM) and converting the read address into a radius of the optical disc.

A radius r(x) at a position where the PSN is ‘x’ is ((S(x)+S(0)/π)̂(1/2). Here, S(0) is π×r(s)̂2 (i.e., an area of a circle up to an LBA (Logical Block Address) 0h(PSN 30000h) position ‘r(s)’). S(x) is (xpsn−0×30000)×Sa (i.e., an area of a doughnut between r(s) and r(x)). Sa is an area ( [symbol] ̂2) of 1 sector.

The optical disc apparatus can move the optical pickup in the outer circumference direction by driving the sled motor in 1 step unit, read an address at a position where the optical pickup is moved and placed, and find a radius corresponding to the read address using the above equation.

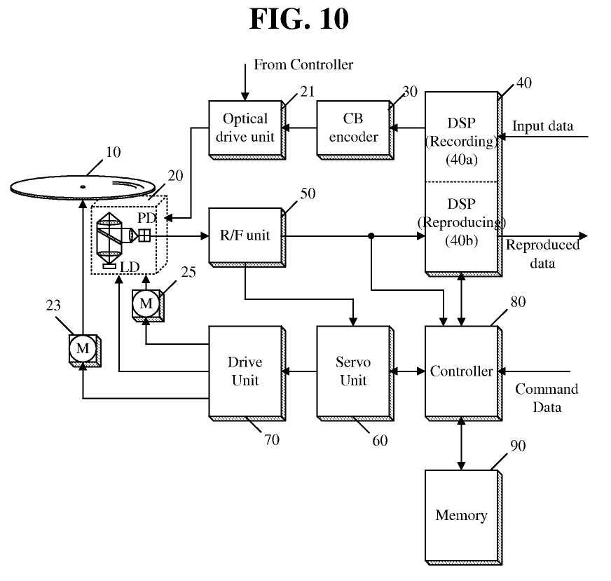

An optical disc recording method according to an embodiment of this document can apply to a disc recording apparatus capable of recording labels on a disc for label recording. FIG. 10 shows an embodiment referring to the construction of an optical disc apparatus to which this document is applied.

The optical disc apparatus according to the embodiment of this document may comprise an optical pickup 20, an optical drive unit 21, a spindle motor 23, a sled motor 25, a channel bit (CB) encoder 30, a digital recording signal processor 40a, a digital playback signal processor 40b, an R/F unit 50, a servo unit 60, a drive unit 70, a controller 80, memory 90, and so on.

The digital recording signal processor 40a adds error correction codes (ECC), etc. to received digital data and converts a format of the digital data into a recording format. The CB encoder 30 converts the data having the recording format into bit streams. The optical drive unit 21 outputs a laser-intensity driving signal according to a received signal. The optical pickup 20 records the data onto an optical disc 10 in response to the laser-intensity driving signal and reads data from a recording plane of the optical disc 10.

The R/F unit 50 filters and normalizes a signal detected by the optical pickup 20 and outputs a binary signal. The R/F unit 50 further generates a tracking error signal TE, a focus error signal FE, a RF signal, etc. The digital playback signal processor 40b restores the binary signal to its original data using a clock whose phase has been synchronized with the binary signal. The servo unit 60 generates servo signals for a focusing servo operation, a tracking servo operation, a sled servo operation, and a spindle servo operation in response to the signal generated by the R/F unit 50. The drive unit 70 drives the spindle motor 23 for rotating the optical disc 10, drives the sled motor 25 for moving the optical pickup 20 in the inner or outer circumference direction, and also drives current for the focusing servo operation and the tracking servo operation for an object lens within the optical pickup 20.

The controller 80 controls the elements of the optical disc apparatus such that data are recorded onto the optical disc or data recorded onto the optical disc are read. The controller 80 controls the optical drive unit 21 such that a laser diode within the optical pickup 20 is driven as power for playback in order to read data from the optical disc 10 or the laser diode is driven as power for recording in order to record data on the optical disc 10.

Further, the controller 80 controls the servo unit 60 and the drive unit 70 based on the RF signal and the servo signals, detected by the optical pickup 20 and outputted from the R/F unit 50, such that the spindle motor operates to rotate the optical disc 10 at a desired velocity and the sled motor 25 operates to move the optical pickup 20 to a desired position. The controller 80 controls the drive unit 70 to apply current to the actuator that supports the object lens within the optical pickup 20 and performs the focusing servo operation and the tracking servo operation.

When recording labels on the label plane, the digital recording signal processor 40a converts data for label recording into a format for label recording. The CB encoder 30 can bypass the converted label data. The controller 80 controls the servo unit 60 and the drive unit 70 such that the focusing servo operation is performed in the feed forward method, and the rotation of the disc, the transfer of the sled motor 25, and the movement of the tracking actuator are also controlled in the feed forward method.

The controller 80 controls the servo unit 60 and the drive unit 70 such that, with respect to the data plane of the disc, the optical pickup 20 is moved to the outer circumference by inputting a driving signal for each step to the sled motor 25 with the focusing servo operation being on and the tracking servo operation being off, turns on the tracking servo operation at each moved position and then detects an address at the corresponding position, and finds a radius at the corresponding position using the above equation.

The controller 80 can find a position and a moved distance according to each input by repeatedly performing the above process by predetermined times or more and can find an error of the moved distance according to each step input. For example, the controller 80 can find a transfer error for four or two steps in a unit of four steps, such as 4n, 4n+1, 4n+2, and 4n+3, or in a unit of two steps, such as 2n and 2n+1, obtain a step pattern having a small error, and store the obtained step pattern in the memory 90.

When recording labels on the label plane of the disc, the controller 80 searches the memory 90 for a step pattern having a small transfer error and controls the servo unit 60 and the drive unit 70 such that the sled motor 25 operates to move the optical pickup 20 to the outer circumference based on steps corresponding to the retrieved step pattern.

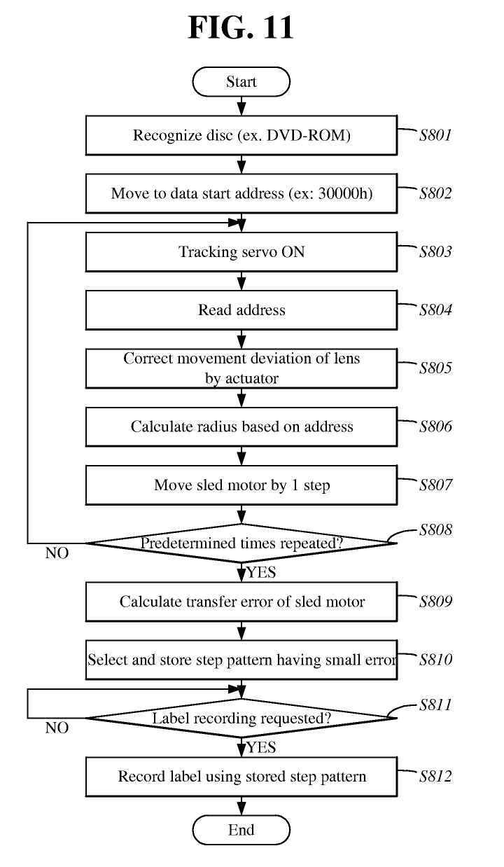

FIG. 11 is a flowchart illustrating an optical disk recording method according to an embodiment of this document.

When the optical disc 10 is seated in the optical disc apparatus, the controller 80 of the optical disc apparatus checks whether the seated plane of the optical disc 10 is the data plane and then recognizes the disc (for example, DVD-ROM) (S801). This is because address information recorded on the data plane of the optical disc 10 is necessary in order to detect a sled movement distance for each step. If the optical disc 10 is recognized as, for example, DVD-ROM, the controller 80 controls the servo unit 60 and the drive unit 70 such that the optical pickup 20 is moved to a position near an initial position (for example, LBA 0h or PSN 30000h) on the optical disc 10 (S802).

The controller 80 controls the servo unit 60 and the drive unit 70 such that the tracking servo operation is on (S803) and reads address information about the moved position on the optical disc 10 (S804). Whenever the tracking servo operation is on, a position (position of the object lens) in the tracking direction of the actuator is slightly changed. Thus, the controller 80 performs an operation for compensating for a movement deviation of the object lens (S805). Here, the process of compensating for a movement deviation of the object lens and the process of reading address information may be switched. The controller 80 calculates a position (radius information) of the object lens on the disc, which is included in the optical pickup 20, based on the read address information (S506).

Alternatively, the controller 80 may repeatedly perform the operation for turning off the tracking servo operation at the moved position, turning on the tracking servo operation again, and reading address information about the moved position by predetermined times (for example, 3 times). Such a process may be performed in order to more accurately detect the current position or the moved distance because eccentric components exist in most of optical discs 10 and a deviation may exist in a moved distance of the object lens.

Next, the controller 80 turns off the tracking servo operation and applies a driving voltage, corresponding to 1 step, to the sled motor 25 through the servo unit 60 and the drive unit 70 such that the sled motor 25 is rotated at an angle corresponding to the 1 step. Accordingly, the optical pickup 20 is moved from the initial position to a position in the outer circumference direction by a distance corresponding to the 1 step (S807).

The controller 80 repeats the process of finding a position (radius) of an address of the moved position of the optical pickup 20 through the steps S803 to S806 and again moving the optical pickup 20 by a distance corresponding to 1 step. The controller 80 repeatedly performs the above process by predetermined times or more until a moved distance according to each step input can be sufficiently obtained (S808). Assuming that, for example, 16 step inputs are necessary in order to rotate the sled motor 25 once, the steps S803 to 5807 may be repeated such that the sled motor is rotated 3 or 5 revolutions or more.

Next, the controller 80 finds a moved distance according to each step input and calculates a transfer error for each step input (S809). The controller 80 may find an average of the moved distances according to the step inputs and find a step pattern having a small transfer error.

In the case where the sled motor 25 has a structure, such as that shown in FIG. 6, step inputs may be classified into 4n, 4n+1, 4n+2, and 4n+3, and a transfer errors for the four step inputs may be found. Further, when labels are printed on the label plane of a disc, a transfer error for a step input may be found based on a unit in which the sled motor 25 is driven. In the case where the sled motor 25 is driven based on two step units, a transfer error for an odd-numbered pattern input and an even-numbered pattern input may be found.

The controller 80 selects a step pattern having a small transfer error and stores it in the memory 90 (S810). For example, in the case where step patterns are classified in an n unit and a step pattern having the smallest transfer error is ‘a’ between 0 and (n−1), the controller 80 may store the step pattern in the form of a (n, a) pair. A criterion for classifying the step patterns in the n unit may become the structure of a step motor or a unit for driving a step motor.

Alternatively, the controller 80 may find a step pattern having the smallest transfer error for each of classification units, such as a 2 unit, a 3 unit, a 4 unit, and a 5 unit, and store a step pattern having the smallest transfer error for each of the classification units in the memory 90. For example, (2, i), (3, j), (4, k), (5, 1), etc. may be stored in the memory 90.

As described above, the operation for storing the step pattern of a step input, having the smallest transfer error in the sled motor 25, in the memory 90 may be performed in a process of manufacturing the optical disc apparatus or may be performed while a user uses the optical disc apparatus. In both cases, to reflect a change in the performance according to the lapse of time, the controller 80 periodically updates a step pattern having the smallest transfer error in the sled motor 25.

Next, when a request to record labels is received from a user (S811), the controller 80 controls the elements of the optical disc apparatus such that the labels are recorded on the label plane of a disc. The controller 80 performs the label recording operation while moving the optical pickup 20 in the outer circumference direction by applying a step pattern, stored in the memory 90, to the sled motor 25 as a step input (S812).

In the case where, in relation to a number of classification units, information about step patterns having the smallest transfer error are stored in the memory 90 in pairs, the controller 80 may select a classification unit corresponding to a unit for driving the sled motor 25 and drive the sled motor 25 using a step pattern having the smallest transfer error, from the corresponding classification unit.

Accordingly, when labels are recorded on the label plane of an optical disc, transfer errors generated by the sled motor can be reduced, and so the recording quality of labels can be improved.

While this document has been described in connection with what is presently considered to be practical exemplary embodiments, it is to be understood that this document is not limited to the disclosed embodiments, but, on the contrary, is intended to cover various modifications and equivalent arrangements included within the spirit and scope of the appended claims.

1. An optical disc recording method, comprising:
checking a step pattern having a small transfer error in a sled motor; and
recording labels on a label plane of an optical disc while driving the sled motor based on the checked step pattern.

2. The optical disc recording method of claim 1, wherein step patterns are classified based on a structure of the sled motor or a unit for driving the sled motor.

3. The optical disc recording method of claim 1, wherein the step patterns having a small transfer error are detected in a process of manufacturing an optical disc apparatus and are stored in memory of the optical disc apparatus.

4. The optical disc recording method of claim 1, further comprising, when a data plane of the optical disc is inserted as a seating plane, detecting a step pattern having a small transfer error and storing the detected step pattern in memory.

5. The optical disc recording method of claim 3, wherein if k(k=0, 1, . . . , n−1)^{th} step pattern of an n number of step patterns has a small transfer error, a (n, k) value is stored in the memory.

6. The optical disc recording method of claim 5, wherein if a number of the (n, k) values with different n values are stored in the memory, a (n, k) value corresponding to a unit for driving the sled motor is selected, and the sled motor is driven based on the selected (n, k) value.

7. An optical disc apparatus, comprising:
an optical pickup configured to read data from a data plane of an optical disc and record data on the data plane or a label plane of the optical disc;
a sled motor configured to move the optical pickup to an inner or outer circumferences;
memory configured to store step patterns having a small transfer error in the optical pickup resulting from the sled motor; and
a controller configured to search the memory for a step pattern having a small transfer error and drive the sled motor based on the retrieved step pattern such that labels are recorded on a label plane of an optical disc.

8. The optical disc apparatus of claim 7, wherein the step patterns are classified based on a structure of the sled motor or a unit for driving the sled motor.

9. The optical disc apparatus of claim 7, wherein the step patterns having a small transfer error are detected in a process of manufacturing the optical disc apparatus and are stored in the memory.

10. The optical disc apparatus of claim 7, wherein when the data plane of the optical disc is inserted as a seating plane, the controller is configured to control the optical pickup and the sled motor such that a step pattern having a small transfer error is detected and stored in the memory.

11. The optical disc apparatus of claim 9, wherein if k(k=0, 1, . . . , n−1)^{th} step pattern of an n number of step patterns has a small transfer error, the controller stores a (n, k) value in the memory.

12. The optical disc apparatus of claim 11, wherein if a number of the (n, k) values with different n values are stored in the memory, the controller is configured to select a (n, k) value corresponding to a unit for driving the sled motor and control driving of the sled motor based on the selected (n, k) value.

13. The optical disc recording method of claim 4, wherein if k(k=0, 1, . . . , n−1)^{th} step pattern of an n number of step patterns has a small transfer error, a (n, k) value is stored in the memory.

14. The optical disc apparatus of claim 10, wherein if k(k=0, 1, . . . , n−1)^{th} step pattern of an n number of step patterns has a small transfer error, the controller stores a (n, k) value in the memory.
